(19) United States
(12) Patent Application Publication
(10) Pub. No.: US 2025/0315051 A1
(43) Pub. Date: Oct. 9, 2025

(54) AUTOMATED DRIVING SYSTEM

(71) Applicant: TOYOTA JIDOSHA KABUSHIKI KAISHA, Toyota-shi Aichi-ken (JP)

(72) Inventors: Hiromitsu URANO, Numazu-shi Shizuoka-ken (JP); Takefumi GOTO, Gotemba-shi Shizuoka-ken (JP); Hiromitsu KOBAYASHI, Nagoya-shi Aichi-ken (JP)

(73) Assignee: TOYOTA JIDOSHA KABUSHIKI KAISHA, Toyota-shi Aichi-ken (JP)

(21) Appl. No.: 19/096,917

(22) Filed: Apr. 1, 2025

(30) Foreign Application Priority Data
Apr. 3, 2024 (JP) 2024-060151

(51) Int. Cl. G05D 1/227; B60W 60/00

(52) U.S. Cl. CPC G05D 1/2279; B60W 60/00; B60W 2556/45

(57) ABSTRACT

The automated driving system includes a remote assistance device that communicates with the vehicle in response to an assistance request from the vehicle and performs remote assistance of the vehicle by a remote operator. In response to occurrence of a predetermined assistance-required situation during execution of the automated driving control, the automated driving system transmits the assistance request for the remote assistance for the assistance-required situation that has occurred. The automated driving system receives an assistance determination of the remote assistance by the remote operator from the remote assistance device and executes the automated driving control in the assistance-required situation in accordance with the received assistance determination. The automated driving system sets a period for continuing communication with the remote assistance device from a time point of receiving the assistance determination and receives a second assistance determination for the remote assistance by the remote operator during the period.

### CROSS-REFERENCE TO RELATED APPLICATION

The present application claims priority under 35 U.S.C. § 119 to Japanese Patent Application No. 2024-060151, filed on Apr. 3, 2024, the contents of which application are incorporated herein by reference in their entirety.

### TECHNICAL FIELD

The present disclosure relates to an automated driving system that performs automated driving control of a vehicle. In particular, the present disclosure relates to the automated driving system including remote assistance of a vehicle.

### BACKGROUND

An automated driving system for a vehicle is considered which is configured to request a remote operator to remotely assist the vehicle in response to occurrence of a predetermined situation during execution of automated driving control of the vehicle. For example, Patent Literature 1 discloses a system including a remote assistance unit that performs remote assistance of a vehicle (automated driving vehicle) by a remote operator when the vehicle arrives at an assist point. In addition, as documents showing the technical level of the present technical field, there are the following Patent Literatures 2 and 3.

### LIST OF RELATED ART

Patent Literature 1: Japanese Patent Application Laid-Open No. 2019-175209
Patent Literature 2: Japanese Patent Application Laid-Open No. 2022-172948
Patent Literature 3: Japanese Patent Application Laid-Open No. 2023-011353

### SUMMARY

In general, a remote operator performs remote assistance of a vehicle by operating a remote assistance device to check the surrounding situation of the vehicle. The automated driving system of the vehicle continuously performs the automated driving control of the vehicle according to the determination of the remote assistance by the remote operator. Conventionally, after receiving once the determination of the remote assistance by the remote operator, the automated driving system ends the remote assistance each time. However, there is a possibility that the surrounding situation of the vehicle has changed significantly at the timing when the automated driving control is performed in accordance with the received determination of the remote assistance. In such a case, there is a problem in that the automated driving system cannot respond to the change in the surrounding situation and cannot continue the automated driving control.

An object of the present disclosure is to provide a technique that can suppress inadvertent termination of remote assistance by a remote operator and smoothly perform automated driving control.

A first aspect of the present disclosure relates to an automated driving system for a vehicle. The automated driving system includes processing circuitry configured to perform automated driving control of the vehicle and a remote assistance device that communicates with the vehicle in response to an assistance request from the vehicle and performs remote assistance of the vehicle by a remote operator. In response to occurrence of a predetermined assistance-required situation during execution of the automated driving control, the processing circuitry is configured to transmit the assistance request for requesting the remote assistance for the assistance-required situation that has occurred. The processing circuitry is configured to receive an assistance determination of the remote assistance by the remote operator from the remote assistance device and execute the automated driving control in the assistance-required situation in accordance with the received assistance determination. The processing circuitry is configured to set a period for continuing communication with the remote assistance device from a time point at which the assistance determination is received and receive a second assistance determination of the remote assistance by the remote operator during the period.

According to the present disclosure, a watchful-waiting period in which communication with the remote assistance device is continued from a point in time at which an assistance determination of remote assistance by a remote operator is received is set. Also during the watchful-waiting period, the remote operator can make a second assistance determination. Thus, it is possible to suppress inadvertent termination of the remote assistance by the remote operator and to smoothly perform the automated driving control of the vehicle.

### BRIEF DESCRIPTION OF DRAWINGS

FIG. 1 is a diagram showing an overall configuration of an automated driving system according to an embodiment;

FIG. 2A is a diagram showing a basic processing sequence related to remote assistance of a vehicle by a remote operator;

FIG. 2B is a diagram showing another basic processing sequence related to remote assistance of a vehicle by a remote operator;

FIG. 3A is a diagram showing a processing sequence related to extension of a watchful-waiting period during a gaze scene;

FIG. 3B is a diagram showing another processing sequence related to extension of a watchful-waiting period during a gaze scene;

FIG. 4A is a diagram showing a processing sequence in the case of ending extension of a watchful-waiting period;

FIG. 4B is a diagram showing another processing sequence in the case of ending extension of a watchful-waiting period; and

FIG. 5 is a flowchart showing a processing flow of processing executed by the control device according to the embodiment in relation to extension of a watchful-waiting period.

### DETAILED DESCRIPTION

Hereinafter, embodiments of the present disclosure will be described with reference to the drawings. In the drawings, the same or corresponding elements are denoted by the same reference numerals, and the description thereof will be simplified or omitted.

### 1. Automated Driving System

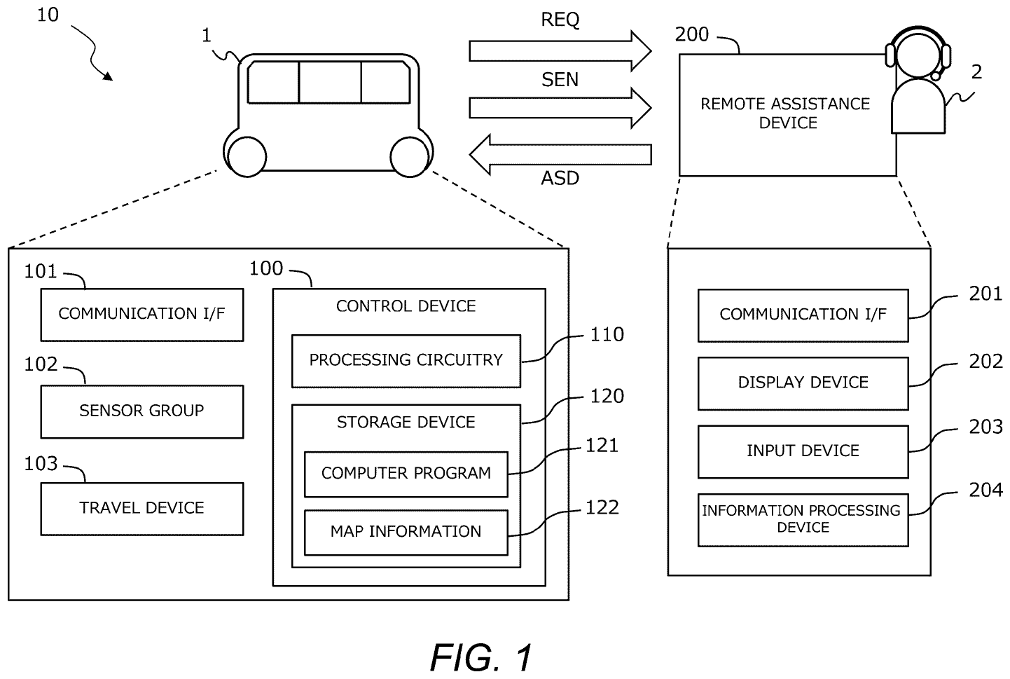

FIG. 1 is a diagram showing an overall configuration of an automated driving system 10 according to the present embodiment. The automated driving system 10 provides an automated driving function of the vehicle 1. That is, the vehicle 1 is an automated driving vehicle. The automated driving system 10 includes a remote assistance device 200. The remote assistance device 200 is operated by a remote operator 2. As described below, the automated driving function provided by the automated driving system 10 includes remote assistance of the vehicle 1 by the remote operator 2. The vehicle 1 and the remote assistance device 200 are configured to be able to communicate with each other via a communication network configured by a mobile communication system, the Internet, or the like.

The vehicle 1 includes a communication interface (communication I/F) 101, a sensor group 102, a travel device 103, and a control device 100.

The communication I/F101 is an interface for communicating with an external device in the vehicle 1 to transmit and receive information. The vehicle 1 transmits and receives information to and from the remote assistance device 200 via the communication I/F101.

The sensor group 102 includes various sensors such as a recognition sensor, a vehicle state sensor, and a position sensor. The recognition sensor recognizes (detects) a surrounding situation of the vehicle 1. Examples of the recognition sensor include a camera, a LiDAR, and a radar. The vehicle state sensor detects a state of the vehicle 1. The vehicle state sensor includes a speed sensor, an acceleration sensor, a yaw rate sensor, a steering angle sensor, and the like. The position sensor detects the position and the direction of the vehicle 1. For example, the position sensor includes a global navigation satellite system (GNSS) sensor.

The travel device 103 includes a driving device, a braking device, and a steering device. The steering device steers the wheels. The driving device is a power source that generates a driving force. Examples of the driving device include an internal combustion engine, an electric motor, and an in-wheel motor. The braking device generates a braking force. Each device of the travel device 103 includes an actuator that can be controlled by the control device 100. The actuators of the respective devices are controlled, whereby the travel device 103 is controlled.

The control device 100 is a computer that controls the vehicle 1. The control device 100 includes processing circuitry 110 and a storage device 120.

The processing circuitry 110 executes various kinds of processing. The processing circuitry 110 may be implemented as, for example, a general-purpose processor, a special-purpose processor, a central processing unit (CPU), a graphics processing unit (GPU), an application specific integrated circuit (ASIC), a field-programmable gate array (FPGA), an integrated circuit, a conventional circuit, or a combination of one or more of these. In general, a processor including transistors and other circuitry is an example of processing circuitry 110. The processing circuitry 110 may also be referred to as circuitry. The circuitry may be hardware programmed to implement or perform the functions described in this disclosure.

The storage device 120 stores various kinds of information necessary for execution of processing of the processing circuitry 110. The storage device 120 is configured by a recording medium such as a random access memory (RAM), a read only memory (ROM), a solid state drive (SSD), or a hard disk drive (HDD). The storage device 120 stores a computer program 121 executable by the processing circuitry 110 and map information 122. The computer program 121 is configured by a plurality of instructions describing processing to be executed by the processing circuitry 110. The computer program 121 may be recorded in a computer-readable recording medium. The processing circuitry 110 that executes the computer program 121 and the storage device 120 cooperate with each other to realize the functions of the control device 100.

The control device 100 acquires detection information SEN (hereinafter, referred to as “sensor detection information SEN”) of various sensors of the sensor group 102. The sensor detection information SEN includes a camera image, surrounding situation information, vehicle state information, position information, and the like. The camera image is an image captured by a camera. The surrounding situation information indicates a surrounding situation of the vehicle 1 detected by the recognition sensor. The surrounding situation information includes information such as relative positions, relative speeds, numbers, and attributes of objects (for example, pedestrians, other vehicles, road structures, traffic lights, signs, and the like) around the vehicle 1. The vehicle state information indicates a state (for example, a speed, a steering angle, or the like) of the vehicle 1 detected by the vehicle state sensor. The position information indicates the position and the orientation of the vehicle 1 detected by the position sensor.

The control device 100 performs at least automated driving control of the vehicle 1. For example, the control device 100 generates a travel plan of the vehicle 1 based on the sensor detection information SEN and the map information 122. Further, the control device 100 generates a target trajectory necessary for traveling in accordance with the traveling plan of the vehicle 1 based on the sensor detection information SEN. The target trajectory includes a target position and a target velocity. Then, the control device 100 controls the travel device 103 (the driving device, the braking device, and the braking device) such that the vehicle 1 follows the target trajectory. The automated driving control of the vehicle 1 is realized by the control of the travel device 103.

When a predetermined situation (hereinafter, referred to as a “assistance-required situation”) in which remote assistance by the remote operator 2 is required occurs during execution of the automated driving control, the control device 100 transmits an assistance request REQ for requesting remote assistance for the occurred assistance-required situation to the remote assistance device 200. At this time, the control device 100 temporarily interrupts the automated driving control. The assistance-required situation is typically a situation in which automated driving determination (for example, start, start of right or left turn, lane change, or the like) is difficult in the automated driving control of the vehicle 1. For example, the assistance-required situation includes a situation where the vehicle is about to pass through an intersection where there is no traffic light or where a traffic light cannot be sufficiently recognized, a situation where the vehicle is about to turn right or left on a road with a lot of people, a situation where the vehicle is about to start from a bus stop, and the like. The control device 100 may be configured to determine whether or not the assistance-required situation occurs as a part of the automated driving control. The situation to be set as the assistance-required situation may be appropriately given according to the content of the automated driving control to be implemented.

When the remote assistance device 200 receives the assistance request REQ from the vehicle 1, the remote assistance device 200 establishes communication with the vehicle 1. The control device 100 communicates with the remote assistance device 200 via the communication I/F101. The control device 100 transmits at least a part of the sensor detection information SEN to the remote assistance device 200 during communication with the remote assistance device 200.

The remote assistance device 200 may be one of a plurality of remote assistance devices managed by a management apparatus (not illustrated). In this case, the management device may receive the assistance request REQ from the vehicle 1 and determine the remote assistance device 200 to be assigned to the vehicle 1. The remote assistance device 200 may establish the communication of the vehicle 1 in response to the result of the assignment.

After establishing communication with the vehicle 1, the remote assistance device 200 performs remote assistance of the vehicle 1 by the remote operator 2. The remote assistance device 200 includes a communication interface (communication I/F) 201, a display device 202, an input device 203, and an information processing device 204.

The communication I/F201 is an interface for communicating with an external device of the remote assistance device 200 to transmit and receive information. The remote assistance device 200 transmits and receives information to and from the vehicle 1 via the communication I/F201.

The display device 202 is a device for performing various displays to the remote operator 2. The display of the display device 202 is controlled by the information processing device 204. The display device 202 is configured by a display, a touch screen, or the like.

The input device 203 is a device for receiving various inputs from the remote operator 2. The input received by the input device 203 is transmitted to the information processing device 204. The input device 203 is configured by a keyboard, a pointing device, a touch pad, a switch, and the like.

The information processing device 204 is a computer that controls the remote assistance device 200. The information processing device 204 includes processing circuitry that executes various kinds of processing and a storage device that stores various kinds of information necessary for the processing circuitry to execute the processing. The storage device stores a computer program executable by the processing circuitry. The processing circuitry that executes the computer program and the storage device cooperate with each other to realize the functions of the information processing device.

While the remote assistance device 200 is communicating with the vehicle 1, the information processing device 204 receives the sensor detection information SEN transmitted from the vehicle 1 via the communication I/F201. The information processing device 204 displays information necessary for remote assistance among the received sensor detection information SEN on the display device 202. For example, the information processing device 204 displays a camera image or vehicle state information on the display device 202. Thus, the remote operator 2 can check the surrounding situation of the vehicle 1 and the state of the vehicle 1.

In the remote assistance of the vehicle 1, the remote operator 2 performs the assistance determination ASD in response to the assistance request REQ from the vehicle 1. For example, a case where the assistance request REQ is for requesting remote assistance for “a situation in which the vehicle is about to pass through an intersection at which a traffic signal cannot be sufficiently recognized” is considered. In this case, the remote operator 2 determines the state of the traffic signal (red, yellow, or green) as the assistance determination ASD. Alternatively, the remote operator 2 determines, as the assistance determination ASD, a timing at which the traffic light turns green and the vehicle 1 can pass.

The information processing device 204 further displays a display for receiving an input of the assistance determination ASD from the remote operator 2 on the display device 202. For example, the information processing device 204 displays a button to be pressed when the remote operator 2 determines that the vehicle 1 can pass on the display device 202. The remote operator 2 can input the assistance determination ASD by operating the input device 203 in accordance with the display of the display device 202. The information processing device 204 transmits the input assistance determination ASD to the vehicle 1.

The control device 100 of the vehicle 1 receives the assistance determination ASD of the remote assistance by the remote operator 2 via the communication I/F101. The control device 100 executes the automated driving control in the assistance-required situation according to the received assistance determination ASD. For example, the control device 100 executes the automated driving control such that the vehicle 1 passes through the intersection in accordance with the assistance determination ASD indicating that the vehicle 1 can pass through the intersection.

In this way, in the automated driving system 10 according to the present embodiment, the remote operator 2 performs remote assistance for the vehicle 1 during execution of the automated driving control of the vehicle 1. The remote assistance by the remote operator 2 avoids a situation in which the automated driving control cannot be continued due to the occurrence of the assistance-required situation. Hereinafter, the remote assistance of the vehicle 1 in the automated driving system 10 according to the present embodiment will be described in more detail.

### 2. Remote Assistance of Vehicle

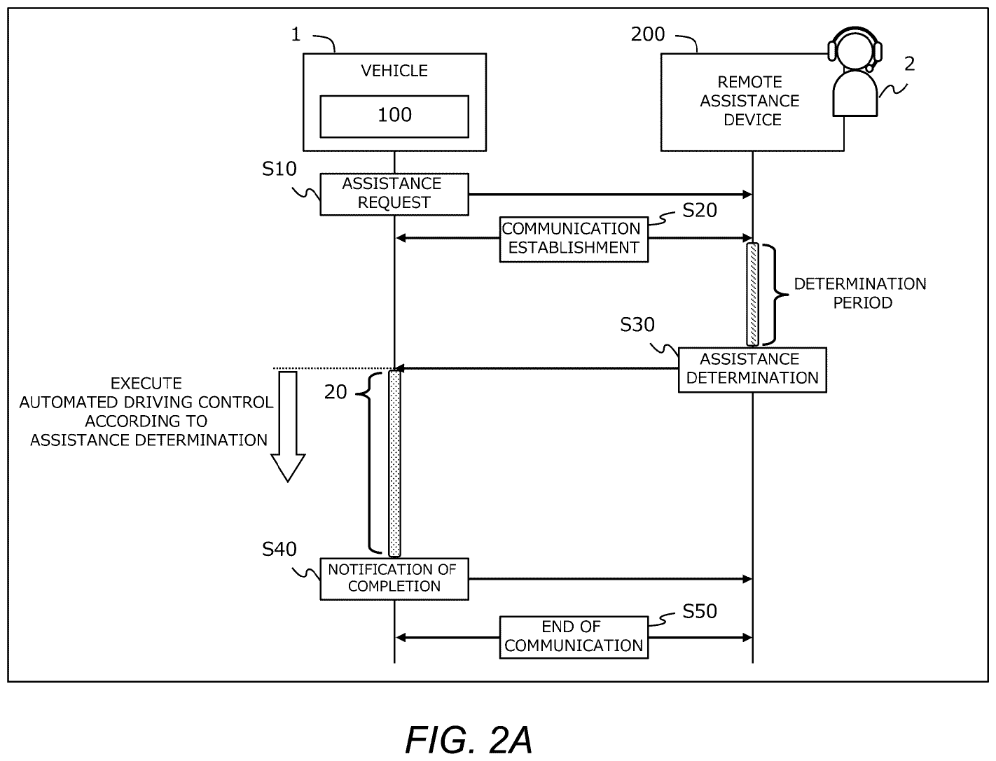

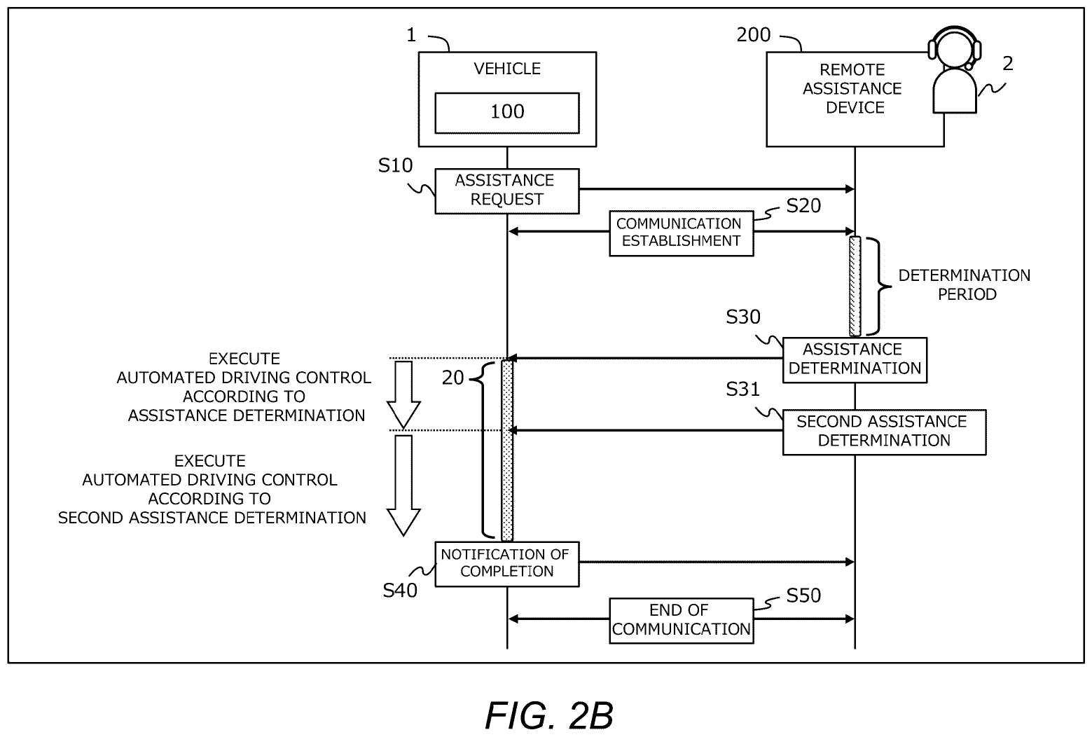

FIGS. 2A and 2B are diagrams showing a basic processing sequence related to remote assistance of the vehicle 1 by the remote operator 2.

As described above, in response to the occurrence of the assistance-required situation during the execution of the automated driving control, the control device 100 of the vehicle 1 transmits the assistance request REQ for requesting the remote assistance for the generated assistance-required situation (step S10). The remote assistance device 200 receives the assistance request REQ from the vehicle 1 and establishes communication with the vehicle 1 (step S20). Thus, the remote operator 2 can remotely assist the vehicle 1. The display device 202 of the remote assistance device 200 displays information necessary for remote assistance among the sensor detection information SEN transmitted from the vehicle 1.

The remote operator 2 checks the surrounding situation of the vehicle 1 and the state of the vehicle 1 from the display of the display device 202. The remote operator 2 is required to perform the assistance determination ASD in response to the assistance request REQ transmitted from the vehicle 1. The remote operator 2 performs the assistance determination ASD by operating the input device 203 after a determination period in which the surrounding situation of the vehicle 1 and the state of the vehicle 1 are considered (step S30).

The control device 100 of the vehicle 1 receives the assistance determination ASD of the remote assistance by the remote operator 2 from the remote assistance device 200. The control device 100 executes the automated driving control of the vehicle 1 according to the received assistance determination ASD. In the present embodiment, the control device 100 further sets a period 20 having a predetermined length from the time point at which the assistance determination ASD is received. The control device 100 continues communication with the remote assistance device 200 during the period 20. That is, the remote operator 2 can check the surrounding situation of the vehicle 1 and the state of the vehicle 1 during the period 20 even after the assistance determination ASD is performed. From this viewpoint, the period 20 can be said to be a “watchful-waiting” period in which the remote operator 2 checks the movement of the vehicle 1 based on the result of the assistance determination ASD. Hereinafter, the period 20 is referred to as a “watchful-waiting period 20”.

The control device 100 is further configured to receive a second assistance determination ASD of the remote assistance by the remote operator 2 during the watchful-waiting period 20. The second assistance determination ASD is an assistance determination ASD performed by the remote operator 2 after canceling the assistance determination ASD that has been already performed. For example, it is assumed that the remote operator 2 performs the assistance determination ASD for allowing the vehicle 1 to pass through the intersection. However, it is assumed that the surrounding situation of the vehicle 1 changes thereafter during the watchful-waiting period 20 and the remote operator 2 considers that it is not desirable for the vehicle 1 to pass through the intersection. In such a case, the remote operator 2 can cancel the assistance determination ASD that allows the vehicle 1 to pass through the intersection and perform the second assistance determination ASD that does not allow the vehicle 1 to pass through the intersection. From this viewpoint, the watchful-waiting period 20 can be said to be a period in which the remote operator 2 can cancel the assistance determination ASD that has been already performed and perform the second assistance determination ASD.

FIG. 2B shows a processing sequence in the case where the remote operator 2 performs the second assistance determination ASD. After the assistance determination ASD is performed (step S30), the remote operator 2 performs the second assistance determination ASD as necessary during the watchful-waiting period 20 (step S31). Of course, as shown in FIG. 2A, the remote operator 2 may not perform the second assistance determination ASD when it is not necessary. When the control device 100 receives the second assistance determination ASD, the control device 100 switches the automated driving control being executed to the automated driving control according to the second assistance determination ASD.

The control device 100 may set the length of the watchful-waiting period 20 according to the generated support required situation. It is considered that the length of the period in which the remote operator 2 should check the trend of the vehicle 1 based on the result of the assistance determination ASD varies depending on the content of the generated assistance-required situation. Further, it is conceivable that the period in which the remote operator 2 is highly likely to perform the second assistance determination ASD varies depending on the content of the generated assistance-required situation. Therefore, for example, the control device 100 sets the length of the watchful-waiting period 20 so that the longer these periods are, the longer the watchful-waiting period 20 is. The storage device 120 may store data in which each support required situation is associated with the length of the watchful-waiting period 20 to be set. The control device 100 may set the length of the watchful-waiting period 20 with reference to the data stored in the storage device 120 for the generated assistance-required situation. With such a configuration, it is possible to set the watchful-waiting period 20 having an appropriate length according to the generated assistance-required situation.

After the watchful-waiting period 20 has elapsed, the control device 100 notifies the remote assistance device 200 of the completion of the remote assistance (step S40). When the completion of the remote assistance is notified from the vehicle 1, the remote assistance device 200 ends the communication with the vehicle 1 (step S50). Thus, the remote assistance of the vehicle 1 by the remote operator 2 is ended. The control device 100 of the vehicle 1 can continuously perform the automated driving control.

### 3. Extension of Watchful-Waiting Period

### 3-1. Overview

As described above, in the remote assistance of the vehicle 1 according to the present embodiment, the watchful-waiting period 20 is set after the control device 100 of the vehicle 1 receives the assistance determination ASD of the remote assistance by the remote operator 2. The watchful-waiting period 20 is a watchful-waiting period in which the remote operator 2 checks the trend of the vehicle 1 based on the result of the assistance determination ASD. The watchful-waiting period 20 is a period in which the remote operator 2 can perform the second assistance determination ASD after performing the assistance determination ASD once. By setting the watchful-waiting period 20 in this way, the automated driving control according to the second assistance determination ASD is enabled, and it is possible to suppress the occurrence of a situation in which the surrounding situation of the vehicle 1 changes significantly and the automated driving control cannot be continued. Further, it is possible to alleviate the psychological burden on the remote operator 2 for performing the assistance determination ASD.

Incidentally, even after the set watchful-waiting period 20 has elapsed, the surroundings of the vehicle 1 may be in a scene in which the determination of the remote operator 2 is highly likely to change (hereinafter, referred to as a “gaze scene”). The gaze scene can also be said to be a scene in which the surrounding situation of the vehicle 1 is likely to change. While the scene is the gaze scene, it is considered that the remote operator 2 may perform the second assistance determination ASD. Therefore, the control device 100 according to the present embodiment determines whether or not the surroundings of the vehicle 1 are the gaze scene. The control device 100 is configured to extend the watchful-waiting period 20 while the surroundings of the vehicle 1 are the gaze scene.

The following three specific examples can be given as the gaze scene.
(a) a scene in which a time to collision (TTC) with an object in the vicinity of the vehicle 1 closest to the vehicle 1 is less than a predetermined time
(b) Scene in which the number of objects around the vehicle 1 is equal to or larger than a predetermined number
(c) Scene in which the vehicle 1 is in a predetermined region with poor visibility

When the TTC with the object in the vicinity of the vehicle 1 closest to the vehicle 1 is less than the predetermined time, it may be necessary to determine to cause the vehicle 1 to avoid collision with the object. Therefore, the specific example (a) of the gaze scene is a scene in which the determination of the remote operator 2 is highly likely to change. According to the specific example (a), the watchful-waiting period 20 is extended until the TTC with the object in the vicinity of the vehicle 1 closest to the vehicle 1 becomes equal to or longer than the predetermined time. The predetermined time may be stored in the storage device 120 in advance. The control device 100 can determine whether or not the scene is the gaze scene of the specific example (a) by acquiring the relative position and the relative speed of the object around the vehicle 1 with reference to the surrounding situation information of the sensor detection information SEN.

When the number of objects around the vehicle 1 is equal to or larger than the predetermined number, the situation of the object to which attention has not been paid may suddenly change. Therefore, the specific example (b) of the gaze scene is a scene in which the determination of the remote operator 2 is highly likely to change. According to the specific example (b), the watchful-waiting period 20 is extended until the number of objects around the vehicle 1 falls below the predetermined number. The predetermined number may be stored in the storage device 120 in advance. The control device 100 can determine whether or not the specific example (b) is the gaze scene by acquiring the number of objects around the vehicle 1 with reference to the surrounding situation information of the sensor detection information SEN.

When the vehicle 1 is in a predetermined area where the visibility of the surroundings is poor, the situation in which the surroundings of the vehicle 1 can be recognized may suddenly change. Therefore, the specific example (c) of the gaze scene is a scene in which the determination of the remote operator 2 is highly likely to change. According to the specific example (c), the watchful-waiting period 20 is extended until the vehicle 1 exits from the predetermined area in which the visibility of the surroundings is poor. The control device 100 can determine whether or not the specific example (c) of the gaze scene is performed based on the position information of the sensor detection information SEN and the map information 122 in which the predetermined region with poor visibility is registered in advance.

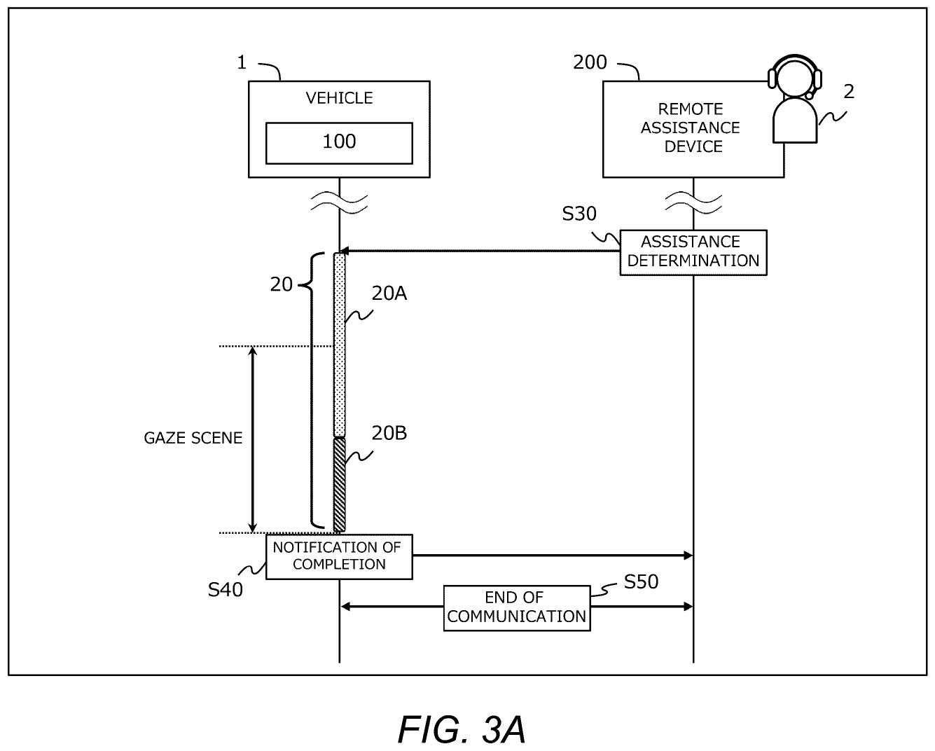

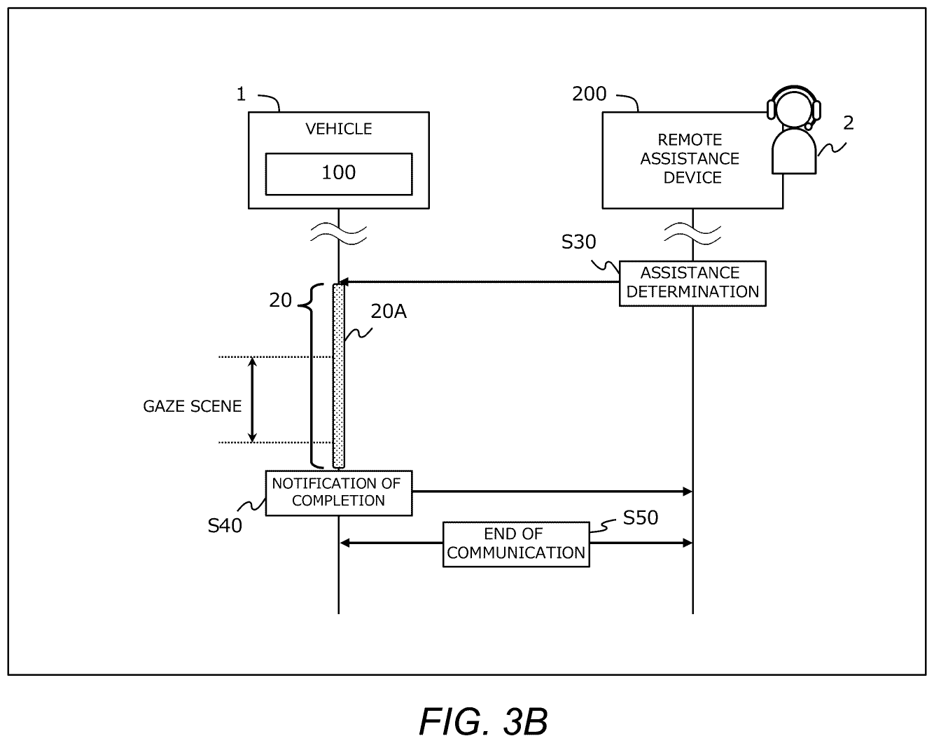

FIG. 3A is a diagram illustrating a processing sequence in a case where the watchful-waiting period 20 is extended while the current scene is the gaze scene. When the control device 100 of the vehicle 1 receives the assistance determination ASD of the remote assistance by the remote operator 2 from the remote assistance device 200, the control device 100 sets the watchful-waiting period 20. The watchful-waiting period 20 set here is a period 20A (hereinafter, referred to as a “base period 20A”) of a predetermined duration or a duration corresponding to the generated assistance-required situation. In the example illustrated in FIG. 3A, a gaze scene occurs during the base period 20A of the watchful-waiting period 20. The gaze scene continues even after the base period 20A has elapsed. Therefore, the control device 100 extends the watchful-waiting period 20 even after the base period 20A elapses while the current scene is the gaze scene. When the gaze scene ends, the extension of the watchful-waiting period 20 ends. Then, the control device 100 notifies the remote assistance device 200 of the completion of the remote assistance (step S40). That is, as shown in FIG. 3A, the watchful-waiting period 20 is a period obtained by combining the base period 20A and the extended period 20B (hereinafter referred to as “extended period 20B”).

By extending the watchful-waiting period 20 during the gaze scene in this way, it is possible to prevent the remote assistance from ending in a scene in which the determination of the remote operator 2 is highly likely to change. As a result, it is possible to suppress the occurrence of a situation in which the automated driving control cannot be continued.

Note that, when the gaze scene ends before the base period 20A elapses, the watchful-waiting period 20 is not extended. FIG. 3B is a diagram illustrating a processing sequence in a case where the watchful-waiting period is not extended. In the example illustrated in FIG. 3B, the gaze scene occurs during the base period 20A of the watchful-waiting period 20, and the gaze scene ends during the base period 20A. Therefore, as shown in FIG. 3B, the watchful-waiting period 20 is equivalent to the base period 20A. The base period 20A can also be referred to as the minimum period of the watchful-waiting period 20.

### 3-2. Condition for Ending Extension of Watchful-Waiting Period

The watchful-waiting period 20 is extended during the gaze scene, but the gaze scene may continue endlessly depending on the surrounding situation of the vehicle 1. In such a case, if the watchful-waiting period 20 is continuously extended, the remote assistance for the vehicle 1 is continued endlessly. This is not desirable from the viewpoint of the efficiency of assistance for the entire vehicle that is the target of remote assistance and the human cost of the remote operator 2. Therefore, the control device 100 according to the present embodiment is configured to end the extension of the watchful-waiting period 20 during the gaze scene under a certain condition.

The first condition for ending the extension of the watchful-waiting period 20 is that the watchful-waiting period 20 has been extended to a predetermined maximum period. The maximum period may be stored in the storage device 120 in advance. When the watchful-waiting period 20 is extended to a certain extent, it is considered that the possibility that the remote operator 2 performs the second assistance determination ASD is low. Therefore, when the watchful-waiting period 20 is extended to the maximum period, the watchful-waiting period 20 is ended, and thus, the efficiency of assistance and the reduction of human cost are prioritized.

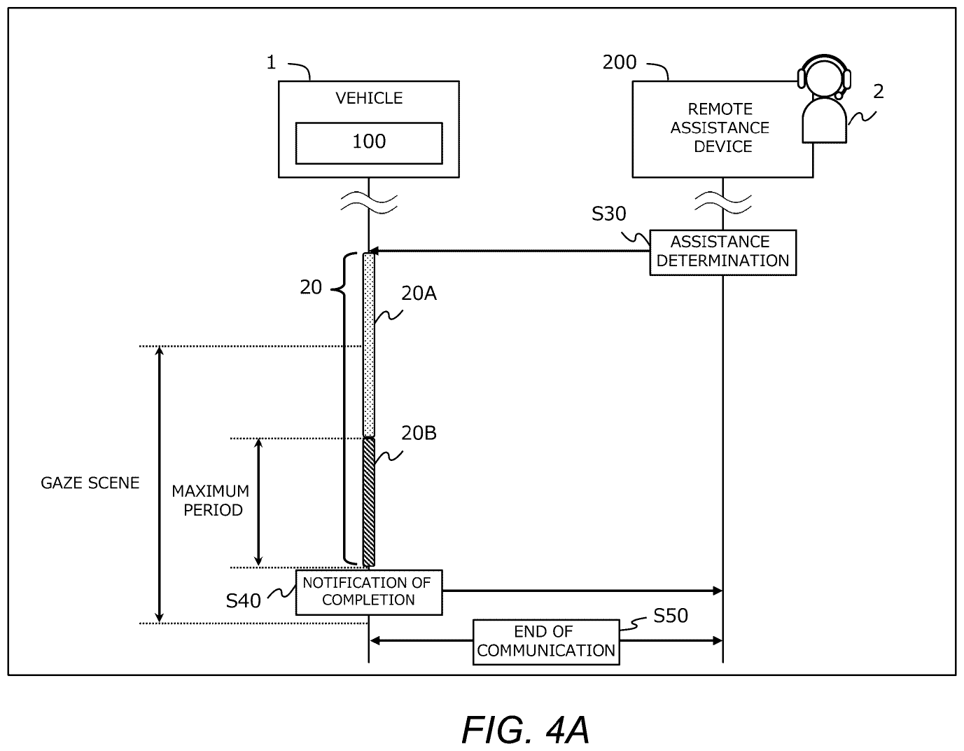

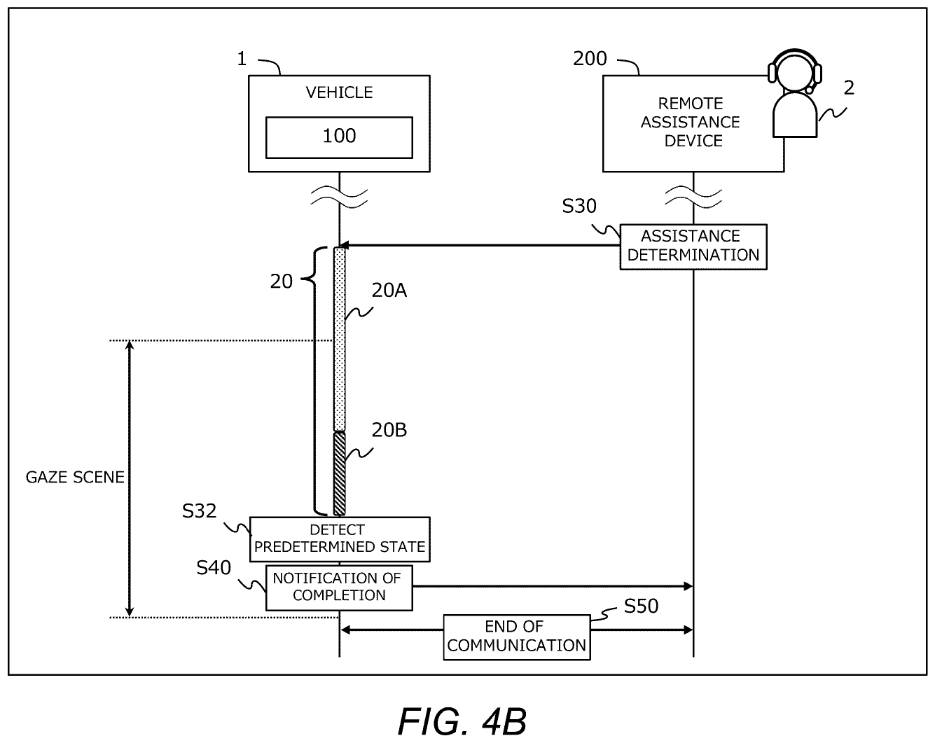

FIG. 4A is a diagram showing a processing sequence in a case where the watchful-waiting period 20 is extended to the maximum period. In the example shown in FIG. 4A, the extended period 20B of the watchful-waiting period 20 is the maximum period. Since the extended period 20B has reached the maximum period, the control device 100 ends the extension of the watchful-waiting period 20. Then, the control device 100 notifies the remote assistance device 200 of the completion of the remote assistance (step S40).

The second condition for ending the extension of the watchful-waiting period 20 is that the vehicle 1 is in a predetermined state corresponding to the generated support required situation. When the automated driving control in the assistance-required situation is executed in accordance with the assistance determination ASD and the vehicle 1 enters a certain state, it is considered that the possibility that the remote operator 2 performs the second assistance determination ASD is low. For example, when the assistance-required situation is a situation in which the vehicle 1 is about to pass through an intersection without a traffic light, the predetermined state is that the speed of the vehicle 1 is equal to or higher than a predetermined speed (for example, 40 km/h). For example, when the assistance-required situation is a situation where the vehicle 1 is going to turn right or left on a busy road, the predetermined state is that the turning of the vehicle 1 has been completed (the yaw rate is equal to or less than a predetermined value). The predetermined state corresponding to the assistance-required situation may be stored in the storage device 120 for each assistance-required situation. The control device 100 can detect that the state of the vehicle 1 becomes a predetermined state corresponding to the assistance-required situation with reference to the vehicle state information of the sensor detection information SEN.

FIG. 4B is a diagram showing a processing sequence in a case where the vehicle 1 is in a predetermined state corresponding to the assistance-required situation while the watchful-waiting period 20 is extended. In the example illustrated in FIG. 4B, the control device 100 detects that the vehicle 1 is in a predetermined state corresponding to the assistance-required situation in the extended period 20B (step S32). The control device 100 ends the extension of the watchful-waiting period 20 since the control device 100 detects that the vehicle 1 is in the predetermined state. Then, the control device 100 notifies the remote assistance device 200 of the completion of the remote assistance (step S40).

As described above, by ending the extension of the watchful-waiting period 20 during the gazing scene under a certain condition, it is possible to prioritize the efficiency of support and the reduction of human cost when it is considered that the remote operator 2 is unlikely to perform the second assistance determination ASD.

### 3-3. Processing Flow

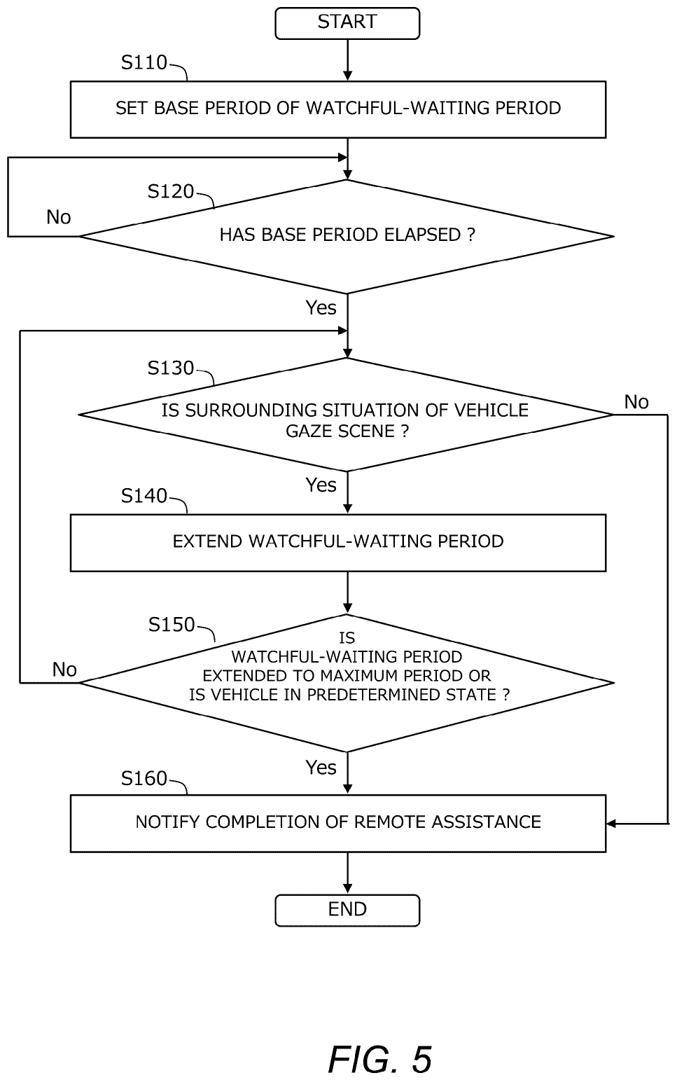

FIG. 5 is a flowchart illustrating a processing flow of processing executed by the control device 100 in relation to extension of the watchful-waiting period 20. The processing flow illustrated in FIG. 5 is started when the assistance determination ASD of the remote assistance by the remote operator 2 is received from the remote assistance device 200. In step S110, the control device 100 sets a base period 20A of the watchful-waiting period 20. The control device 100 continues the watchful-waiting period 20 until the base period 20A elapses (No in step S120).

After the base period 20A has elapsed (Yes in step S120), the control device 100 determines whether or not the surrounding situation of the vehicle 1 is the gaze scene (step S130).

When the surrounding situation of the vehicle 1 is not the gaze scene (step S130; No), the control device 100 notifies the remote assistance device 200 of the completion of the remote assistance without extending the watchful-waiting period 20 (step S160).

When the surrounding situation of the vehicle 1 is the gaze scene (step S130; Yes), the control device 100 extends the watchful-waiting period 20 (step S140).

After step S140, next, in step S150, the control device 100 determines whether the watchful-waiting period 20 is extended to the maximum period or the vehicle 1 is in a predetermined state corresponding to the generated assistance-required situation.

When the watchful-waiting period 20 is not extended to the maximum period and the vehicle 1 is not in the predetermined state (step S150; No), the control device 100 repeats the process related to step S130 again.

When the watchful-waiting period 20 is extended to the maximum period or the vehicle 1 is in the predetermined state (Yes in step S150), the control device 100 ends the extension of the watchful-waiting period 20 and notifies the remote assistance device 200 of the completion of the remote assistance (step S160).

### 4. Effect

As described above, according to the present embodiment, the watchful-waiting period 20 in which the communication between the vehicle 1 and the remote assistance device 200 is continued from the time point at which the vehicle 1 receives the assistance determination ASD of the remote assistance by the remote operator 2 is set. During the watchful-waiting period 20, the remote operator 2 can check the result of the assistance determination ASD. Further, during the watchful-waiting period 20, the remote operator 2 can perform the second assistance determination ASD. Thus, even when the surrounding situation of the vehicle 1 changes, the automated driving control can be performed in accordance with the second assistance determination ASD by the remote operator 2, and the occurrence of a situation in which the automated driving control cannot be continued can be suppressed. As described above, according to the present embodiment, it is possible to suppress the remote assistance by the remote operator 2 from being carelessly ended, and to smoothly perform the automated driving control of the vehicle 1. Further, it is possible to alleviate the psychological burden on the remote operator 2 for performing the assistance determination ASD.

What is claimed is:

1. An automated driving system for a vehicle, comprising:
processing circuitry configured to perform automated driving control of the vehicle; and
a remote assistance device that communicates with the vehicle in response to an assistance request from the vehicle and performs remote assistance of the vehicle by a remote operator, wherein
the processing circuitry is configured to:
transmit, in response to occurrence of a predetermined assistance-required situation during execution of the automated driving control, the assistance request for requesting the remote assistance for the assistance-required situation that has occurred;
receive an assistance determination of the remote assistance by the remote operator from the remote assistance device;
execute the automated driving control in the assistance-required situation in accordance with the received assistance determination;
set a period for continuing communication with the remote assistance device from a time point at which the assistance determination is received; and
receive a second assistance determination of the remote assistance by the remote operator during the period.

2. The automated driving system according to claim 1, wherein
the processing circuitry is further configured to extend the period while surroundings of the vehicle are in a predetermined gaze scene in which a determination of the remote operator is likely to change.

3. The automated driving system according to claim 2, wherein
the gaze scene includes at least one of a scene in which a time to collision with an object in the surroundings of the vehicle closest to the vehicle is less than a predetermined time, a scene in which a number of objects in the surroundings of the vehicle is equal to or greater than a predetermined number, and a scene in which the vehicle is in a predetermined region in surroundings with poor visibility.

4. The automated driving system according to claim 2, wherein
the processing circuitry is further configured to terminate an extension of the period after the period is extended to a predetermined maximum period.

5. The automated driving system according to claim 2, wherein
the processing circuitry is further configured to terminate the extension of the period when the vehicle enters a predetermined state corresponding to the assistance-required situation while the period is extended.
